(19) United States
(12) Patent Application Publication
(10) Pub. No.: US 2002/0156159 A1
(43) Pub. Date: Oct. 24, 2002

(54) Viscosity enhanced natural rubber latex dipping media and dipped articles of greater thickness prepared therefrom

(76) Inventor: Shimon Amdur, Indianapolis, IN (US)

Correspondence Address: William G. Conger, Brooks & Kushman P.C., 22nd Floor, 1000 Town Center, Southfield, MI, 48075-1351, US

(21) Appl. No.: 10/099,652

(22) Filed: Mar. 15, 2002

Related U.S. Application Data
(63) Continuation-in-part of application No. 09/294,989, filed on Apr. 19, 1999, now abandoned.
(63) Continuation-in-part of application No. 09/614,334, filed on Jul. 12, 2000, now abandoned.
(60) Provisional application No. 60/082,335, filed on Apr. 20, 1998.

(51) Int. Cl. C08K 3/00

(52) U.S. Cl. 523/334

(57) ABSTRACT

Increasing the viscosity of latex dipping media is achieved by adding a minor amount of a viscosity-increasing fumed silica. The more viscous latex dispersions allow preparation of dipped articles of increased thickness at the same latex solids concentration. The dipped articles, for example surgical gloves, contain low levels of extractable proteins.

### CROSS-REFERENCE TO RELATED APPLICATIONS

This application claims the benefit of U.S. provisional application Ser. No. 60/082,335, filed Apr. 20, 1998, and is a continuation-in-part of U.S. application Ser. No. 09/294,989, filed Apr. 19, 1999, and a continuation-in-part of U.S. application Ser. No. 09/614,334, filed Jul. 12, 2000, all of which are incorporated herein by reference.

### BACKGROUND OF THE INVENTION

1. Field of the Invention

This invention relates to compositions for straight dipping of relatively thick rubber articles from an aqueous latex dispersion, and to the reduction of discoloration and the elimination or reduction of allergenic proteins in natural rubber latex products prepared thereby. Moreover, the present invention relates to the addition of fumed silica to latex dispersions for the purpose of enhancing latex viscosity and eliminating the migration of proteins to the surfaces of articles dipped from such latex dispersions.

2. Background Art

Latex viscosity is an important factor in manufacturing of latex dipped goods. Higher viscosity and higher percent solids helps in the building of thicker articles. There are several kinds of viscosity builders. Soluble polymers, for example, increase viscosity but reduce tensile strength.

Latex dispersions also generally contain additives which stabilize the dispersion or latex articles prepared therefrom. Polymeric hindered phenols were patented in 1972, U.S. Pat. No. 3,699,173, as latex stabilizers. Hindered phenols are known as antioxidants. Polymeric hindered phenols improve color stability of dipped rubber latex products.

Allergies caused by proteins in natural latex occur in gloves, condoms, catheters, balloons and many other rubber articles. Protein residues in latex products migrate to the surface and attack the human body through the skin. This problem is of particular concern to a large number of healthcare workers.

Latex gloves are the most commonly used latex articles and obviously the ones with the most problems. There is a major distinction between powdered and powder-free gloves. Ordinary latex gloves are powdered for two reasons. The first is to protect the cured latex from sticking to itself. The other is to provide a lubricant to aid in donning the gloves.

Latex proteins are evaluated colorimetrically by extracting the rubber with water, using the procedure identified as ASTM D5712. Powdered latex gloves are considered to be “dirty,” i.e., containing from one hundred to eight hundred micrograms of protein per gram of rubber. On the other hand, washed powder-free latex gloves are considered to be “clean,” i.e., they contain below 28 micrograms of protein per gram rubber, the lowest detection level of the ASTM D5712 test. Instead of introducing powder to cover the cured rubber and to facilitate removal from the molds, the gloves may be chlorinated to form a lubricated, non-tacky smooth surface. It is believed that chlorination or oxidation of the surface also creates a kind of protective skin which limits migration of residual proteins from the body of the latex to the outer layer. Yet another way of protecting the users of natural rubber latex gloves is by coating the latex with a layer of a polymer. While such a polymer layer will prevent the migration of proteins out of the latex through the coated side, the body of the latex remains “dirty” and proteins can migrate to the surface opposite the coated side. As noted above, extensive washing of the latex article is also effective in removing proteins.

Extensively washed latex gloves present different kinds of problems. It was believed that there is a relationship between hydration and compromised barriers in surgical gloves. It was concluded at J. ALLERGY AND CLINICAL IMMUNOLOGY (1996) Abst. 575, p. 326, that “surgical gloves, long assumed effective barriers against blood-borne pathogens, may not be as effective as originally thought, and, further, improperly manufactured gloves may cause a serious threat to healthcare workers and patients.” The theory behind such beliefs is that proteins in the body of the glove are washed out and replaced by water molecules, creating diffusible channels through which small diameter particles, such as the HIV virus, could pass.

The idea of adding silica to natural rubber has existed for a long time. In 1995, a process was patented, U.S. Pat. No. 5,458,588, for compounding latex with an aqueous dispersion of fumed silica to increase tensile strength of dipped articles. However, the U.S. Pat. No. 5,458,588 patent discloses that the silicas added to the latex dipping media do not increase the viscosity of the latex, and hence do not cause thicker latex articles to be produced by dipping processes. Based on the thickness of the articles produced by dipping, it appeared that the viscosity of the latex may actually have been decreased as compared to compositions containing no silica. See, e.g., Tables 1 and 2 of the U.S. Pat. No. 5,458,588 patent.

### SUMMARY OF THE INVENTION

The present invention pertains to an improvement in latex dipping media and to latex articles prepared therefrom, in which a viscosity-increasing fumed silica is added to the latex dipping medium to increase the viscosity to such an extent that dipped articles of greater thickness can be prepared from a dipping medium of a given latex solids content. The latex articles also exhibit a surprisingly low level of extractable proteins.

### DETAILED DESCRIPTION OF THE PREFERRED EMBODIMENTS

The introduction of fumed silica dispersions into latex can have a minor, major or no effect on latex viscosity. It has now been surprisingly discovered that the processing of natural rubber latex dispersions with suitable, viscosity-increasing fumed silica particles, including some fumed silicas having a mean diameter as measured by intensity of from about 100 to about 130 nanometers (nm) and a mean diameter as measured by volume of from about 65 to about 95 nm, can result in latex dispersions having enhanced viscosity and in relatively clean latex goods with “below detection” protein extractables, specifically under 28 microgram of protein per gram of rubber at a broad range of silica of from 1 to 5%. A non-silica rubber blank has 105 microgram of proteins per gram of rubber which is considered “dirty,” according to an analysis performed using the ASTM D5712 method.

As noted above, latex goods with “below detection” protein content have been manufactured by chlorination, polymer coating or extreme washing, while reversing articles inside-out for drying. In the proposed latex dipping process of the present invention, washing is performed on-line and since the latex is “clean,” there is no need for polymer coating or chlorinating. Moreover, if the alleged compromising of barriers in latex gloves is true, this danger will be reduced or eliminated when silica serves as a sealing agent between the rubber particles.

While not wishing to be bound by any particular theory, the mechanism by which the dispersed fumed silica reduces proteins in the latex is believed to be as follows: when the latex is in the natural state, the particles are presumed to possess an adsorbed layer of protein-lipid complexes. As a consequence of the addition of ammonia for preserving the latex concentrate, the lipid materials are believed to hydrolyze slowly, releasing fatty acids. It is further postulated that the proteins would stay adsorbed on the latex particles throughout the compounding process. It has been proposed that the silica attaches itself to the proteins on the surface of the latex particle which helps keep them bound. To the contrary, I propose that the silica particles attach to the surface of the rubber particles, thereby displacing the proteins.

Irrespective of the action of fumed silica on extractable proteins, in the present invention, the claimed silicas show a significant increase in viscosity of the latex dispersion dipping medium, and as a result allow the preparation of thicker latex articles by dipping.

The fumed silica is produced by conventional processes. For example, silicon tetrachloride or a variety of chlorosilanes, e.g., methyltrichlorosilane may be “pyrolyzed” or “hydrolyzed” in the presence of water in the gaseous state to form a fumed silica product. While the same general reaction is characteristic of all fumed silica products, the products themselves may be quite different depending on the ratio of reactive ingredients, the initial reaction temperature, and the rapidity of quenching, among other product variables. As a result, the degree of porosity of individual particles, their tendency to agglomerate, and the morphology of the agglomerate produced may all be varied. For example, fumed silica of a given particle size may be produced with a wide range of porosity and surface area, and vice versa. Various fumed silicas may also exhibit differences in agglomeration in aqueous dispersions. These properties of fumed silica and their relationship to the process of preparing fumed silica is well known to those skilled in the art.

In order to increase the viscosity of the latex, it is necessary to add a viscosity-increasing silica. A viscosity-increasing silica is defined as one which increases the viscosity by an amount such that upon the preparation of a latex article by dipping, an increase in thickness of at least 20% is realized, more preferably at least 40%, yet more preferably 70% or more, at the same latex rubber solids level. The increased thickness is most preferably in the range of 50% to 400%, more preferably in the range of 50% to 300%. This increased thickness is produced by appreciably more viscous latex dispersions, the increase in viscosity being minimally 30%, more preferably minimally 50%. Most preferably, the viscosity is increased by from 50% to about 500%, more preferably 50% to 400%, and most preferably 70% to 300%. These increases in thickness and viscosity are with respect to a composition free of viscosity-increasing silica, for example by comparing a latex dispersions containing 1.0 wt. % of silica to an otherwise identical composition containing no silica.

The particle size of the viscosity-increasing silica is impossible to specify exactly, since the viscosity is at least as much dependent on surface area as on particle size, and with a given particle size, the surface area can vary widely. However, the fumed silica preferably ranges in mean diameter from 65 to 130 nm. The ability of any particular silica to increase viscosity may be assessed by adding 1.0 wt. % silica to the latex dipping medium and measuring the viscosity change as compared to an identical dipping medium prepared analogously without silica. The increase in thickness of a dipped article can be similarly assessed by dipping articles from the respective dispersions and measuring the cured thickness of the articles.

The latex compositions of the present invention are preferably prepared by combining an aqueous dispersion of fumed silica particles having a mean diameter of from about 65 to about 130 nm, such as marketed by the Wacker Silicones Corporation of Adrian, Mich. , as HR 3017 fumed silica, wherein the pH of the dispersion has been adjusted to from about 9.5 to about 10.5, preferably from about 9.7 to about 10.2 such as by the addition of a base which may be concentrated ammonia, potassium hydroxide, and the like, slowly to a natural rubber latex which has been thoroughly mixed and mixing the latex/silica combination until viscosity stabilizes, i.e., on the order of from about 0.5 to about 16 hours. While not wishing to be bound by any theory, it is believed that the base reacts with the fatty acids present in the latex to produce an anionic soap which acts as a colloidal or anionic stabilizer for the latex thus permitting the addition of fumed silica to the latex without disruption of the delicate latex balance. The presence of this stabilizing effect prevents the premature coagulation of the latex and formation of prefloc during compounding and processing of the latex.

In addition, as is well known in the art, other materials, commonly known as “rubber chemicals” that impart particularly desired properties to the finished dipped goods may be added to the latex, i.e., curing, cross-linking or vulcanizing agents such as sulphur, vulcanization accelerators and activators, including metal oxides and hydroxides, i.e., zinc, calcium, sodium and organic accelerators such as the dithiocarbamates, xanthates, thiourea, mercapto compounds, etc., antioxidants, such as ethoxylated polymeric hindered phenols prepared by polymerizing a dialkyl hindered phenol with an ethoxylated alkyl phenol employing formaldehyde in an acid medium, as disclosed in U.S. Pat. No. 3,699,173, and other antidegradents in amounts that vary depending on characteristics of the latex, solids content and properties desired.

Preferably, the rubber chemicals employed, if not water soluble, are of a particle size approximately equal to the rubber particle size in the latex. Moreover, water insoluble materials should be emulsified or dispersed in water prior to blending or mixing into the latex. After compounding of the rubber chemicals and latex, the mixture is aged or stored for about twenty-four hours. The amount of fumed silica subsequently added to the mixture is from about 0.1 to about 5.0% by weight fumed silica in the natural rubber latex, based on the total weight of the dispersion.

The proposed method has certain advantages over those heretofore known. The latex compositions prepared by the method of the present invention produce dipped cured latex sheath goods such as surgical gloves substantially free of proteins. Moreover, the use of the viscosity-increasing silica of the present invention allows latex articles of identical or increased thickness to be prepared from latexes of lesser natural rubber content. It is well recognized that the stability of rubber latexes, whether natural or synthetic, generally decreases as the latex solids increase. High solids elastomer latexes may settle, coagulate, or even gel, for example. Addition of viscosity-increasing silica allows compounding the natural rubber latex at considerably lower solids, thus decreasing the chance of coagulation or other undesirable events during shipping or storage.

In a preferred embodiment of the present invention, the novel silica latex compositions of the present invention are formed into surgical gloves by means well known to those skilled in the art.

Having generally described this invention, a further understanding can be obtained by reference to certain specific examples which are provided herein for purposes of illustration only and are not intended to be limiting unless otherwise specified.

### COMPARATIVE EXAMPLE 1

A homogeneous stable latex composition is prepared by stirring 0.15 parts by weight potassium hydroxide, 0.5 parts by weight zinc oxide, 0.2 parts by weight sodium dibutyldithiocarbamate, 1.0 parts by weight dispersed sulfur and 1.0 parts by weight of Vanox SKT, a polymeric hindered phenol marketed by R.T. Vanderbilt Company, into 100 parts by weight ammonia preserved natural rubber latex. Stirring was continued for 10 hours and the mixture was then aged for twenty-four hours.

1.0 part by weight of CABOSPERSE fumed silica dispersion marketed commercially by the Cabot Corporation, in the form of a 17.0% solids aqueous dispersion stabilized with ammonia to a pH of 10.0 was blended into the latex mixture and stirred for 3.0 hours.

Surgical gloves were dipped from this latex bath using dipping and curing procedures well-known to those skilled in the art.

Dipped latex products prepared as described in the Examples as well as latex gloves prepared using no silica were evaluated for residual protein content using the following assay. Three dipped latex samples are weighed, after which the samples are cut into small pieces. The sample is then extracted for 2 hours at 37° C. in phosphate buffered saline. The extracts are collected, filtered and centrifuged to remove particulates and then assayed for total antigenic protein. The samples are assayed using the LEAP assay, an advanced test, 100 times more sensitive than ASTM 5712 developed at the Guthrie Research Institute, see Vol. 61, No. 2, GUTHRIE JOURNAL (1992). The limit of the LEAP test is 0.2 ppm. The limit of ASTM 5712 is 28 ppm. The resulting data reported in Table 1 is calculated by using latex protein extracted from compounded ammoniated latex with and without added silica, as the reference standard. The data is expressed as antigenic latex protein in micrograms/grams of latex. To aid in understanding the mechanism of protein removal, Table 2 shows the levels of proteins extracted and analyzed following the ASTM D5712 method.

A further method of latex allergen analysis is the RAST Inhibition Test developed at the Reference Laboratory for Dermatology and Clinical Immunology at John Hopkins University School of Medicine. The RAST Inhibition Test is a biochemical test in which natural rubber latex is treated with a solution of various chemicals which teach the allergenic proteins from the rubber. The allergenic proteins recovered are then separated by absorption. The test presents a relative test number and not a parts per million value as is the case with ASTM D571 2 and the LEAP Assay reported in Table 1.

The results of the RAST Inhibition Test are reported in Table 3.

In all cases, based on the results reported in Tables 1, 2 and 3, the addition of fumed silica to natural rubber latex compositions markedly reduced the amount of allergenic protein present in latex articles dipped from such compositions.

### EXAMPLE 2

A homogeneous stable latex composition is prepared by stirring 0.15 parts by weight potassium hydroxide, 0.5 parts by weight zinc oxide, 0.2 parts by weight sodium dibutyldithiocarbamate, 1.0 part by weight dispersed sulfur and 1.0 part by weight of Vanox SKT, a polymeric hindered phenol, into 100 parts by weight ammonia preserved natural rubber latex. Stirring was continued for 10 hours and the mixture was then aged for twenty-four hours.

0.3 parts by weight of silica HR 3017 dispersion marketed commercially by the Wacker Silicones Corporation, as a 17% solids dispersion stabilized with ammonia to a pH of 10 was blended into the latex mixture and stirred for 3.0 hours.

### EXAMPLE 3

A homogeneous stable latex composition is prepared by stirring 0.15 parts by weight potassium hydroxide, 0.5 parts by weight zinc oxide, 0.2 parts by weight sodium dibutyldithiocarbamate, 1.0 part by weight dispersed sulfur and 1.0 part by weight of Vanox SKT, a polymeric hindered phenol, into 100 parts by weight ammonia preserved natural rubber latex. Stirring was continued for 10 hours and the mixture was then aged for twenty-four hours.

2.0 parts by weight of silica HR 3017 dispersion as a 17% solids dispersion stabilized with ammonia to a pH of 10 was blended into the latex mixture and stirred for 3.0 hours.

Dipped latex products prepared as described in Examples 2 and 3 as well as latex without silica were evaluated using the LEAP assay. Results are shown in Table 4. It was found that adding silica dispersions containing a viscosity-increasing fumed silica to natural latex compositions will increase latex viscosity and result in dipping thicker articles. The effect of fumed silica dispersion additives on latex viscosity was evaluated by measuring with Brookfield viscometer using spindle #2 at 12 rpm. Dipped part thickness was measured with a caliper. Results for viscosity and a dipped part thickness are shown in Table 5 and Table 6, respectively. Table 7 demonstrates that 6 month accelerated color stability of thicker dipped articles is enhanced by the addition of an antioxidant.

TABLE 1
Residual Protein Testing in Dipped Latex With and Without Silica
by the LEAP Assay. Guthrie Research Institute. Sayre, PA

| Rubber Sample | Guthrie Research | | Allergenic Proteins |
|---|---|---|---|
| Lot # | Test # | Silica | (ppm) |
| 149603-3 | 12253 | No Silica | 26.8 |
| 149603-3 | 12253b | No Silica | 16.6 |
| 149603-3 | 12253c | No Silica | 15.3 |
| 109607-2 | 11652 | With Silica | <0.2 |
| 109607-2 | 11652b | With Silica | <0.2 |
| 109607-2 | 11652c | With Silica | <0.2 |

TABLE 2
Protein Contamination and Fumed Silica Compounding in Natural Latex

| | | | Proteins Extracted, |
|---|---|---|---|
| | Guthrie Research | Fumed Silica | ASTM 05712. |
| Rubber Lot # | Test # | (wt. %) | microgram/gram |
| 017401-1 | 9335 | 0 | 105 |
| 109607-2 | 9814 | 1.0 | <28 |
| 109607-3 | 9815 | 1.0 | <28 |
| 109607-1 | 9813 | 2.5 | <28 |
| 168901-4 | 9364 | 5.0 | <28 |

TABLE 3
Latex Allergen Analysis by the RAST Inhibition Test Method
The John Hopkins University Medical School, Baltimore, Maryland
Dr. Robert G. Hamilton, January 26, 1998

| | | Latex Allergen |
|---|---|---|
| Description | IgE-Blood Latex Serum | Units/ml |
| Powdered Examination | F8138 | 1450 |
| Glove, Positive Control | H0896 | 3082 |
| Latex Rubber | F8138 | 12 |
| No Silica | F8138 | 10 |
| | H0896 | 36 |
| | H0896 | 31 |
| Latex Rubber | F8138 | <1 |
| With Silica | F8138 | <1 |
| | H0896 | <1 |
| | H0896 | <1 |
| Vinyl Glove | F8138 | <1 |
| Negative Control | H0896 | <1 |

TABLE 4
Residual Allergenic Protein Testing in Dipped Latex With and Without
Fumed Silica by the LEAP Assay. Guthrie Research Institute, Sayre, PA

| Rubber Sample | | Silica | Allergenic Proteins |
|---|---|---|---|
| Lot # | Guthrie Test # | (wt. %) | (ppm) |
| 019906-04 | 16639 | 0 | 20.9 |
| 099906-04 | 16629 | 0.3 | 3.1 |
| 0279807-1 | 14432 | 2.0 | <0.2 |

TABLE 5
Brookfield Viscosity of Latex With and Without Fumed Silica Dispersions

| | | Brookfield Viscosity, |
|---|---|---|
| Silica Dispersion | Silica (wt. %) | Spindle #2, 12 rpm (CPS) |
| No Silica | 0 | 300 |
| Cabosperse | 1.0 | 330 |
| Silica HC 3017 | 1.0 | 1200 |

TABLE 6
Thickness of Natural Latex Films Obtained With One Dip in Latex
With and Without Fumed Silica Dispersions

| Silica Dispersion | Silica (wt. %) | Film Thickness (mill) |
|---|---|---|
| No Silica | 0 | 1.5-2.0 |
| Cabosperse | 1.0 | 1.5-2.0 |
| Silica HC 3017 | 1.0 | 6.0-8.0 |

TABLE 7
Color Stability of Films
With and Without Polymer Hindered Phenol Antioxidant

| | Color Stable/ | Color Stable/ |
|---|---|---|
| Film Thickness | Antioxidant | No Antioxidants |
| 6 mill | Yes | Yes |
| 40 mill | Yes | No |

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. In a method of preparing dipped latex articles by dipping a form into a dipping dispersion comprising a rubber latex, the improvement comprising adding to said aqueous dispersion an amount of a viscosity increasing fumed silica effective to increase the viscosity of the dispersion by about 30% or more, or effective to increase the cured thickness of said dipped latex articles by 40% or more.

2. The method of claim 1, wherein said viscosity-increasing fumed silica is a hydrophillic fumed silica having a mean volume particle size of from65nm to95nm.

3. The method of claim 1, wherein said viscosity-increasing silica is added to said dispersion in an amount of from about 0.1 weight percent to about 5 weight percent based on the total weight of the dispersion.

4. The method of claim 3, wherein the viscosity of said dispersion is increased by about 100% or more.

5. The method of claim 3, wherein the cured thickness of said dipped latex article is increased by 40% or more.

6. The method of claim 1, wherein said viscosity-increasing silica is added to said rubber latex in the form of an aqueous dispersion having a pH of about 10 or higher.

7. The method of claim 1, wherein said dipping dispersion further comprises one or more rubber chemicals selected from the group consisting of curing agents, crosslinking agents, vulcanizing agents, vulcanizing accelerators, vulcanizing activators, and antioxidants.

8. The method of claim 1, wherein said dipped latex articles contain less extractable proteins as compared to a latex article prepared from an otherwise identical composition free of viscosity-increasing silica.

9. The method of claim 8, wherein said extractable proteins are below 28 μg protein per gram of rubber as measured by ASTM method D5712.

10. The method of claim 1, wherein said viscosity-increasing silica increases the viscosity of said dipping dispersion by at least 20% at a concentration of 1.0 weight percent silica.

11. A cured, dipped latex article prepared by the process of claim 1 which has a content of protein extractables less than 28 μg rubber as measured by ASTM method D5712.

12. A cured, dipped latex article prepared by the process of claim 1 having a thickness which is from 3 to 4 times the thickness of an article prepared from a dipping dispersion containing no viscosity-increasing silica.

13. A cured, dipped latex article prepared by the process of claim 1 having a thickness which is from 3 to 4 times the thickness of an article prepared from a dipping dispersion containing no viscosity-increasing silica but containing the same amount of a non-viscosity-increasing silica relative to the amount of viscosity-increasing silica.
